(19) United States
(12) Patent Application Publication
(10) Pub. No.: US 2021/0270736 A1
(43) Pub. Date: Sep. 2, 2021

(54) DIFFRACTIVE BIOSENSOR

(71) Applicant: DR. JOHANNES HEIDENHAIN GmbH, TRAUNREUT (DE)

(72) Inventors: Wolfgang HOLZAPFEL, Obing (DE); Michael KUGLER, Trostberg (DE); Marco SCHADE, Traunstein (DE)

(21) Appl. No.: 17/261,259

(22) PCT Filed: Apr. 16, 2019
(86) PCT No.: PCT/EP2019/059853

§ 371 Date: Jan. 19, 2021

(30) Foreign Application Priority Data
Jul. 18, 2018 (DE) 10 2018 212 013.7

(51) Int. Cl. G01N 21/47; G02B 6/42; G02B 26/04

(52) U.S. Cl. CPC G01N 21/4788; G02B 6/4215; G02B 6/42; G01N 2021/479; G01N 2201/0635; G01N 2201/0633; G02B 26/04

(57) ABSTRACT

A diffractive biosensor for the selective detection of biomolecules includes a substrate and an optical biograting situated on the substrate, the biograting having periodically arranged receptors for the biomolecules and the efficiency of a diffraction of incident light, and thus the intensity of a measuring light beam arriving in a detector, is a function of a mass coverage of the biograting with the biomolecules to be detected. The biosensor has a device for generating a reference light beam directed to the detector, by which the phase position of stray light arriving in the detector is able to be determined.

### FIELD OF THE INVENTION

The present invention relates to a diffractive biosensor. Such sensors are based on the adsorption of biomolecules to be detected on a diffractive grating for the diffraction of light. The signal from a photodetector for the diffracted light is used as a measure of the mass coverage of the biosensor with biomolecules.

### BACKGROUND INFORMATION

Certain planar waveguides which are situated on a substrate and have an optical grating for the coupling and decoupling of light are conventional in the optical field. In such an optical grating, for example, these are structures which are etched into the substrate or into the waveguide and thus are made of the material of the substrate or the waveguide. The required grating period depends on the wavelength of the used light and on the refractive index of the waveguide. Depending on the coupling angle, the grating period lies in the range of the effective wavelength of the light in the waveguide. It typically amounts to approximately one half of the vacuum wavelength of the light.

Certain gratings for the coupling and decoupling of light are also conventional in the field of biosensors, these gratings being made of biological material and acting as receptors for the biomolecules to be examined. If such biomolecules deposit on the receptors structured to form the grating, the biomolecules form an optically acting grating. Such receptors structured to form a grating with or without adsorbed biomolecules are also referred to below as biogratings. Since the diffraction efficiency of such a biograting depends on the mass coverage of the grating with the biomolecules, it is possible to arrive at a quantitative indication of the mass coverage based on the intensity of the diffracted light measured with the aid of a detector.

PCT Patent Document No. WO 2015/004264 describes a diffractive biosensor in which divergent light is incident through a substrate on an optical grating in order to couple light into a waveguide. The light propagating in the waveguide then impinges upon a biograting acting as a decoupling grating. The decoupled light is focused through the substrate on a detector. The light intensity measured in the detector is a measure of the coverage of the decoupling grating with the biomolecule to be examined. However, the use of two biogratings results in a very low signal because of the dual, weak coupling. Because undesired stray light is also superimposed on the desired measuring light, which furthermore is in a fixed phase relation to the measuring light and may interfere with it, no optimal measuring signals are obtained.

A diffractive biosensor is also described in U.S. Pat. No. 7,008,794. In this case, it is proposed to subtract a background diffraction pattern from the measuring signal in order to emphasize the actually desired signal. Here, too, however, the fixed phase relation between the stray light and the measuring light is not adequately addressed.

Additional biosensors are also described in European Patent Document Nos. 2 618 130, 2 757 374, and 2 929 326.

### SUMMARY

Example embodiments of the present invention provide a diffractive biosensor and a method for its use by which an increase in the measuring accuracy is achieved by reducing the effect of stray light despite the relatively low diffraction efficiencies of the biogratings and disturbing stray light.

A diffractive biosensor for the selective detection of biomolecules is described herein, which has a substrate and an optical biograting situated on the substrate, the biograting having periodically arranged receptors for the biomolecules, and the efficiency of a diffraction of incident light, and thus the intensity of a measuring light beam arriving in a detector, being a function of a mass coverage of the biograting with the biomolecules to be detected. The biosensor has a device for generating a reference light beam directed to the detector by which the phase position of stray light arriving in the detector relative to the measuring light beam is able to be determined.

If this phase position is known, then the negative effect of the stray light in the measuring signal is able to be eliminated.

When illuminating scattering surfaces with coherent light, so-called speckle occurs. This is stray light which interferes with itself with a random phase position and thereby generates a random phase and amplitude distribution. This phenomenon also occurs in diffractive biosensors (e.g., as in the above-mentioned documents) and has an adverse effect on the measuring accuracy. A stray field is coherently superpositioned to the diffractometric measuring field and falsifies it. The two electric fields coherently superposition according to the following relationship:

I_{M+S}=I_{M}+I_{S}+2E_{M}E_{S} cos(φ_{M}−φ_{S})

in which E_{M} and E_{S} represent the electrical field strengths of the measuring field and stray field, respectively, I_{M}=E_{M}² and I_{S}=E_{S}² represent the associated intensities (hereinafter abbreviated to measuring intensity and stray intensity), φ_{M} and φ_{S} represent the respective phases, and I_{M+S} represents the associated total intensity in the detection plane. For example, the formulas apply per pixel of a two-dimensional detector, the location dependency on the detector surface being implicitly included. When the relative phase position Δφ_{MS}=φ_{M}−φ_{S} is constant over time, the interference term 2E_{M}E_{S} cos(φ_{M}−φ_{S}) does not average to zero even in the presence of long integration times. The stray field is then able to be corrected only if the phase difference Δφ_{MS} is known. The device and associated method described herein provide for measuring this phase difference in order to be able to correctly subtract the stray field and thus infer the undisturbed measuring field E_{M} and its intensity I_{M}.

However, stray light is currently not considered at all or only insufficiently in connection with diffractive biosensors. As a rule, it is proposed to determine the intensity of stray field I_{S} separately from the intensity of measuring field I_{M} and to simply subtract its mean value in order to clean up the measuring field. However, this approach is correct only if the phase position of the stray light randomly varies over time and the interference term thus averages out, or it is approximately correct if it is true that the intensity of the measuring field is considerably greater than the intensity of the stray field. For a fixed stray-light phase and measuring intensities close to the detection limit of a sensor, however, this simplified approach does not provide sufficient accuracy.

Undesired stray centers (that is to say, disturbances of all types such as surface roughness, contamination of the surface, grain limits in the waveguide, non-specifically adsorbed particles/biomolecules, etc.) scatter light just like the biograting. However, since the undesired stray centers are not structured but arranged in a random manner, the stray light is radiated in a wide solid angle and not specifically in the direction of the detection location. This is the reason why diffractive biogratings are very robust with regard to non-specific adsorptions.

However, it should be noted that the undesired stray centers—especially in the case of scattering at substrate roughness—are indeed unstructured but fixedly arranged nevertheless. Thus, the phase position of the resulting stray field E_{S} may indeed be random but is still constant over time. Only a very small yet not negligible portion of the stray field is radiated in the direction of the detection location. Through an optimal configuration of the detection optics, only the particular light mode (hereinafter called the measuring mode) that generates the diffractive biograting of the biomolecules to be detected is able to reach the detector and all other modes are blocked by suitable diaphragms and apertures. In this manner, the stray light is suppressed in these other modes and does not reach the detector. However, the stray light that is radiated into the measuring mode cannot be suppressed as a matter of principle. It contributes to detected total intensity I_{M+S} by a field strength E_{S} and phase φ_{S}. The resulting interference term 2E_{M}E_{S} cos(φ_{M}−φ_{S}) is unable to be averaged out. When measuring intensity I_{M} is ascertained by simply subtracting stray intensity I_{S} from total intensity I_{M}+s (i.e. I_{M}≈I_{M+S}−I_{S}), it includes an error of the magnitude 2E_{M}E_{S} cos(φ_{M}−φ_{S}), which limits the measuring accuracy, especially for E_{M}≈E_{S}.

Stray light in the measuring mode generated by stray centers that are not fixedly positioned, i.e. fluctuating, is able to be suppressed by averaging the detected intensity over time because the expected value of the interference term is zero. Undesired stray light, which is generated in a process that differs from the generation of the measuring light in some parameter (e.g., location, wavelength, polarization, etc.) and thus is not radiated into the measuring mode, is able to be suppressed by utilizing this parameter. The portion of the stray light that is radiated into the measuring mode is produced at the same locations on the substrate as the measuring light and is generated in the same direction and with the same polarization. The measuring light and the stray light component in the measuring mode are therefore inseparably mixed in an optical mode and are no longer able to be separated. All attempts to reduce the stray intensity in the measuring mode, for instance by reducing the coherence length of the light source, by letting the position of the waveguide randomly vibrate or by letting the phase position randomly fluctuate in some other manner, are unsuitable because they destroy, to the same extent, also the coherent measuring intensity. Filtering in the location or k space, e.g., via diaphragms, is also not an option because measuring light and stray light are generated in the same location in the measuring mode or with the same k-vector distribution. The sole possibility for reconstructing the undisturbed measuring intensity then is the measurement of the phase difference Δφ_{MS} between the measuring field and stray field and the coherent subtraction of the stray field.

Only speckle, which occurs during the illumination of scattering surfaces using coherent light, has so far been examined as a concrete example of a stray field E_{S}. A further concrete example (and a special case) of a stray field E_{S} is the optical bias of a biograting.

If a refraction index contrast exists between the webs and gaps of a biograting, then a constant zero signal, which is referred to as bias, occurs as background already without the adsorption of biomolecules to be detected. This bias may superposition to the measuring field, either constructively or destructively, and falsify the measuring field. It is therefore advantageous to minimize or even eliminate the bias by filling the grating gaps with a suitable material (so-called backfilling).

However, in the photolithographic production of such biogratings, it is generally not possible to carry out the backfilling so accurately that the bias completely vanishes, which means that a bias having an unknown algebraic sign usually remains, which affects the measuring accuracy. One possible solution to this problem, for example, is measuring the bias by the addition of a calibration solution, which is complicated, however, and may perhaps not be possible without destruction or reversal.

Completely analogous to the already mentioned speckle, the bias may also be described as an electric stray field E_{S} having a given phase φ_{S} and an intensity I_{S}=E_{S}², which coherently superpositions to measuring field E_{M}. The bias constitutes a special case of such a stray field insofar as—in contrast to speckle—its phase may not be randomly oriented but is oriented either in phase with measuring field E_{M} (φ_{S}=φ_{M}, positive bias), or opposite in phase to measuring field E_{M} (φ_{S}=φ_{M}+180°, negative bias).

When measuring the phase difference Δφ_{MS} between measuring field E_{M} and stray field E_{S}, it is impossible to distinguish whether electrical field E_{S} has its origin in speckle or bias. Thus, the provided method for measuring the phase difference Δφ_{MS} between measuring field E_{M} and stray field E_{S} and the subsequent coherent subtraction of the stray field also constitutes an option for measuring or eliminating the bias.

Particularly advantageous is the related increase in the measuring accuracy of the biosensor because the measuring signal is no longer falsified by the bias or speckle. In addition, there is the advantageous fact that the bias need not be completely eliminated by backfilling, which allows for greater tolerances during the production of such biogratings.

Example embodiments of the present invention provide for measuring the unknown phase difference Δφ_{MS} between measuring field E_{M} and stray field E_{S} in order to then be able to completely deduct the stray field by a coherent subtraction. The sequence scheme is as follows, and the individual steps will be described in greater detail below:
(i) Measuring the required intensity distributions before and after the addition of an analyte with the biomolecules to be detected.
(ii) Performing a phase calculation.
(iii) Recalculating an undisturbed measuring field by a coherent subtraction of the stray field given knowledge of the phase.

In step (i), the accessible intensity distributions are measured. The unknown phase of a light wave is generally able to be determined by interference with a known reference wave. In addition to the already defined field strengths of measuring field E_{M} and stray field E_{S}, the field strength of reference field E_{R} is therefore defined here. The following relationships apply to the respective intensities: I_{M}=E_{M}², I_{S}=E_{S}² and I_{R}=E_{R}². The total intensity of different combinations (i.e. coherent superpositions) of the measuring field, stray field and reference field is denoted as I_{M+S+R}, I_{M+S} etc. The intensity distribution, in particular, is understood as the spatial intensity distribution on a two-dimensional detector (e.g., a camera). The evaluation of these intensity distributions may be performed both per camera pixel and regionally, that is to say, in order to save computing power, certain areas of the camera image may be combined at the expense of accuracy, whereupon the different evaluations may be performed for these regions.

The intensity without the measuring field is able to be measured prior to adding the analyte (background measurement, I_{M}=0), and the intensity with the measuring field can be measured after the addition of the analyte. Reference field I_{R} is able to be switched on and off by simple dimming. In addition, the entire biograting from whose region the measuring field and stray field are emitted may be dimmed in order to record only I_{R}. In this manner, the following five combinations of measuring field, stray field and reference field are experimentally accessible as measuring variables:

I_{M+S+R}=I_{M}+I_{S}+I_{R}+2E_{M}E_{S} cos(φ_{M}−φ_{S})+2E_{M}E_{R}(φ_{R}−φ_{M})+2E_{S}E_{R} cos(φ_{R}−φ_{S})

I_{M+S}=I_{M}+I_{S}+2E_{M}E_{S} cos(φ_{M}−φ_{S})

I_{S+R}=I_{S}+I_{R}+2E_{S}E_{R} cos(φ_{R}−φ_{S})

I_{S}=I_{S}

I_{R}=I_{R}

Not experimentally accessible, on the other hand, are I_{M} and I_{M+R}, because the measuring field always occurs mixed with the stray field in the measuring mode (this constitutes the actual problem). Hereinafter, the goal is the ability to calculate the searched for measuring intensity I_{M}.

As previously mentioned already, in step (ii), the unknown phase of a light wave is able to be determined by interference with a known reference wave. Suitable for this purpose are either carrier wave methods, in which the reference phase is impressed as the carrier frequency (see D. Malacara, lnterferogram analysis for optical testing, Ch. 8 “Spatial Linear and Circular Carrier Analysis”), or phase-shift methods, in which the reference phase is varied in at least three steps (see D. Malacara, lnterferogram analysis for optical testing, Ch. 7 “Phase Shifting Interferometry”). In the final analysis, both methods are similar in that the unknown phase of the output wave to be analyzed is determined. Both methods are briefly described below.

To begin with, the phase calculation with the aid of the carrier wave method will be described.

In the carrier wave method, reference phase φ_{R} is modulated by impressing a carrier frequency f₀, e.g., by the oblique irradiation of the reference wave. In the case of a planar reference wave, reference phase φ_{R} is given as a function of geometry by the following relationship:

φ_{R}=2πf₀ₓx+2πf_{0y}y.

The resulting intensity distribution on a detector is then characterized by the occurrence of a stripe pattern, also referred to as fringes.

If only the reference wave together with a planar, untilted output wave is irradiated, then the spatial frequency of this stripe pattern precisely matches the carrier frequency because the phase of the output wave is the same in all points. For a random output wave, on the other hand, the maxima of the stripe pattern shift on account of the phase distribution of the output wave. The stripe pattern shifts transversely to the stripe direction. Encoded in the deviations of this resulting stripe pattern from the undisturbed stripe pattern is the desired phase information about the output wave to be analyzed, which is able to be extracted by fitting, or by a Hilbert or Fourier transform, for instance. Corresponding algorithms in many forms are described in the literature. Mentioned as examples are the algorithms according to Takeda, J. Opt. Soc. Am. 72(1) (1982) (Fourier transform of the intensity distribution, deletion of not required frequency components, shifting of the carrier frequency peak to the origin and back transform or S. Wang, Optik 124 (2013), 1897-1901 (abbrev: Quadruple Hilbert transform with subtraction and phase acquisition based on φ=arctan (sin φ/cos φ), see also D. Malacara, lnterferogram analysis for optical testing, Ch. 8 “Spatial Linear and Circular Carrier analysis” for this and further methods.

For a stable phase calculation, it has to be ensured that the reference wave is irradiated at an angle greater than the numerical aperture (plus a safety margin for the complete separation of the reference wave in the Fourier space) of the measuring light and stray light component in the measuring mode. The reference wave must thus be generated outside the biograting so that the transversal k-vector of the reference wave is greater than every transversal k-vector of measuring light kₘₐₓ=2πNA/λ. In other words, the gradient of the wave front of the reference wave must be greater than that of the output wave to be analyzed. In this manner the carrier frequency is separated from the rest of the frequency spectrum, and the aforementioned evaluation methods are able to be used.

Next, the phase calculation with the aid of the phase-shift method will be described.

While in the carrier wave method, the reference phase—defined by the geometry dependency—varies in space on its own, the reference phase has to be actively varied, i.e., shifted, in the phase-shift method.

In this context, the phase delay of the reference wave is able to be achieved by many different methods. Described in the literature, for example, is the insertion of a plane-parallel (delay) glass/plastic plate into the reference beam path, the introduction of an electro-optical phase-delay element such as a liquid crystal element, shifting a mirror in the reference beam path with the aid of a linear actuator, or shifting a diffractive grating perpendicular to the beam in the reference beam path.

The relative phase of the reference wave is set to multiple (at least three) fixed values, and the resulting intensity distributions of the coherent superpositions of the reference wave and the output wave are recorded.

A variety of algorithms for the subsequent calculation of the unknown phase may be used (three-step, four-step, and five-step, etc. methods, continuous methods) (see. D. Malacara, Interferogram analysis for optical testing, Ch. 6 “Phase-Detection Algorithms”). Here, the three-step algorithm with a 120° phase difference between the steps will be described as one example:

Three images of the superposition of the reference and output wave are recorded for this purpose, the reference wave being varied/delayed in phase by a fixed amount (60°, 180° and 300°) between the images in each case. The recorded intensities are offset against one another according to formula A below, and the desired phase difference φ is obtained via the arc tangent:

φ=arctan(−√3(I₁−I₃)/(I₁−2I₂+I₃)), (formula A)

This method may be used because the following applies: Let it be assumed that the three phase delays of the reference wave φ_{R1}, φ_{R2}, φ_{R3}=60°, 180°, 300°. For each point in the image plane with output phase φ, an intensity of the form Iᵢ=a+b·cos (φ+φ_{Ri}) is thereby obtained. This can be reformulated to Iᵢ=a+b·cos φ·cos φ_{Ri}−b·sin φ·sin φ_{Ri}. Following a brief transformation (derivation in D. Malacara, Interferogram analysis for optical testing, Ch. 6.2.1 “120° Three-Step-Algorithm”), the above formula A results, whereby the unknown phase difference between the output wave to be analyzed and the reference wave is unambiguously reconstructed.

One disadvantage of the phase-shift method is the recording of at least three images per intensity distribution, which entails a certain amount of additional work. The advantage of this method is that—in contrast to the carrier wave method—the reference wave need not necessarily be irradiated in an oblique fashion in order to separate it in the k-space.

Using the accessible intensity distribution described in connection with step (i) and the methods described in connection with step (ii) for the ability of measuring the phase of the measuring field and the stray field relative to an irradiated reference field, it is now possible in step (iii) to infer the desired undisturbed measuring intensity Inn.

Different methods, which use up to five of the above output equations, are suitable for this purpose, all having in common that I_{S+R} and I_{M+S+R} have to be measured at least once in order to then reconstruct the unknown phase of the interference term. Two evaluation methods are described in the following text for example.

In a first evaluation method (iii a), images of the intensity distributions of I_{S+R} and I_{M+S+R} are recorded, and the phase difference of the output wave (of stray field E_{S} or the addition of the stray field and measuring field E_{S}+E_{M}) from the reference wave is calculated therefrom according to one of the above methods. Next, an image of intensity distribution I_{R} is recorded and, with knowledge of the individual phase difference from the above formulas for I_{S+R} and I_{M+S+R}, the amounts of the electrical fields E_{S} or E_{S}+E_{M} are calculated. Since the electrical fields E_{S} or the addition of the stray field and measuring field E_{S}+E_{M} are now known in terms of their amount and phase, they are able to be vectorially subtracted from one another, so that the desired E_{M} is obtained.

More specifically: intensity distribution I_{S+R} is measured. By applying one of the methods for the phase calculation described in step (ii), the phase difference (φ_{R}−φ_{S}) is calculated therefrom. In phase-shift methods, multiple equations with the cos term including the phase difference are obtained in the process, from which the phase is able to be reconstructed. In carrier wave methods, the desired phase information is obtained from the deviations of the stripe pattern from the carrier frequency. Together with a recording of the intensity of reference wave I_{R}, the stray intensity I_{S} is then able to be calculated based on the following relationship:

I_{S}=(±\sqrt{I_{S+R}−I_{R}+I_{R} cos²(φ_{S}−φ_{R})}−\sqrt{I_{R}} cos(φ_{R}−φ_{S}))²

With the amount E_{S}=√I_{S} and phase (φ_{R}−φ_{S}), the complex E-field vector of stray field E_{S} (relative to the reference wave) is now fully known.

Next, I_{M+S+R} is recorded, and the relative phase of combined field E_{M+S}=E_{M}+E_{S} in relation to the reference wave is determined by applying one of the methods described in step (ii). With knowledge of I_{R}, the amount of E_{M+S} is calculated again in a similar fashion from I_{M+S+R}. The complex E-field vector of E_{M+S} relative to the reference wave is now fully known as well in terms of its amount and phase.

The searched-for measuring field E_{M} then results from a vectorial subtraction of E_{M+S} and E_{S}, and after subsequent squaring, I_{M}=|E_{M}|² is obtained. The reference wave phase is eliminated by the subtraction.

An advantage of this method is that only three intensity distributions have to be recorded. If, as an alternative to I_{R}, intensity distributions I_{S} and I_{M}+s are recorded, then the amounts of the electrical fields E_{S} and E_{M+S} are also able to be obtained therefrom by I=|E|², instead of recalculating them after the phase determination from the intensity distributions including the reference waves with the aid of I_{R}. The same result is then obtained with the four intensity distributions I_{M+S+R}, I_{S+R} and I_{S}.

In a second evaluation method (iii b), utilizing all five measuring variables, the intensity

I_{clean}=I_{M+S+R}−I_{M+S}−I_{S+R}+I_{S}=2E_{M}E_{R} cos(φ_{R}−φ_{M})

is first formed, which is already completely free of stray field terms. By applying one of the algorithms described in (ii) for the phase calculation, the phase difference (φ_{R}−φ_{M}) is calculated therefrom. In phase-shift methods (see above), multiple equations with a cos term are obtained in this case from which the phase is able to be reconstructed, whereas it is only one in carrier wave methods. Next, measuring intensity I_{M} is calculated based on the following relationship:

$${I}_{M} = ( \frac{{I}_{M + S + R} - {I}_{M + S} - {I}_{S + R} + {I}_{S}}{2 \sqrt{{I}_{R}} cos ( {φ}_{R} - {φ}_{M} )} )$$

The advantage of this method is that all experimentally accessible information is utilized and a stray field-free intensity distribution is obtained already prior to the phase measurement.

Both the carrier wave method and the phase-shift method involve a coherent subtraction. The measuring uncertainty of these methods is limited by the measuring uncertainty of the relative phase position and amounts to 2E_{M}E_{S} cos(Δφ). The relative measuring error rel.Fehler of measuring intensity I_{M} thus amounts to

$$rel . Fehler = \frac{2 \sqrt{{I}_{M}} \sqrt{{I}_{S}} cos ( Δ φ )}{{I}_{M}} = \frac{2 \sqrt{{I}_{S}} cos ( Δ φ )}{\sqrt{{I}_{M}}}$$

and the standard deviation σ of the relative error, σ_{rel.Fehler}, amounts to

$${σ}_{rel . Fehler} = \frac{2 \sqrt{{I}_{S}} σ ( cos ( Δ φ ) )}{\sqrt{{I}_{M}}} \approx \frac{2 \sqrt{{I}_{S}} σ ( Δφ )}{\sqrt{{I}_{M}}} .$$

In the simple subtraction I_{M+S}−I_{S}, the phase position is completely unknown, and with

σ(cos(Δφ))=1/\sqrt{2}

the following results:

σ_{rel.Fehler}=\sqrt{I_{M}}/\sqrt{2I_{S}}.

Every method that measures the phase more precisely thus already represents an improvement over conventional methods. In order to achieve high accuracy, it must be ensured that the relative phase position does not change between the different measurements. In particular the required exchange of the sample between the background measurement (I_{S}, I_{S+R}) and the actual intensity measurement (I_{M+S}, I_{M+S+R}) is critical because temperature T, analyte concentraction C and pressure p may vary.

In general, it furthermore applies that the interferometric contrast of two waves satisfies the relationship:

ξ=2\sqrt{(I_{R}I_{S})}/(I_{R}+I_{S}),

that is to say, it reaches its maximum ξ=1 for I_{R}=I_{S}. Both for the carrier wave method and the phase-shift method this means that the intensity of reference wave I_{R} should be set such that it roughly corresponds to that of the stray light background Is.

In the following example embodiments of the present invention, these aspects regarding the phase stability and intensity of the reference wave are taken into account, especially for the generation of a reference wave. Additional features and details of example embodiments of the present invention are described below with reference to the Figures.

### BRIEF DESCRIPTION OF THE DRAWINGS

FIGS. 1-4 illustrate a first example embodiment according to the carrier wave method, with a planar reference wave and a focusing biograting.

FIGS. 5-9 illustrate a second example embodiment according to a phase-shift method, with a spherical reference wave and a collimating biograting.

FIGS. 10-13 illustrate a third example embodiment according to a phase-shift method, with an external reference wave and a focusing biograting.

FIGS. 14-16 illustrate a fourth example embodiment with a Bragg deflection within a waveguide and a cell spacer.

FIG. 17 illustrates a fifth example embodiment with an external reference wave and a focusing biograting, which is imaged by an optics system onto the detector.

### DETAILED DESCRIPTION

### First Example Embodiment

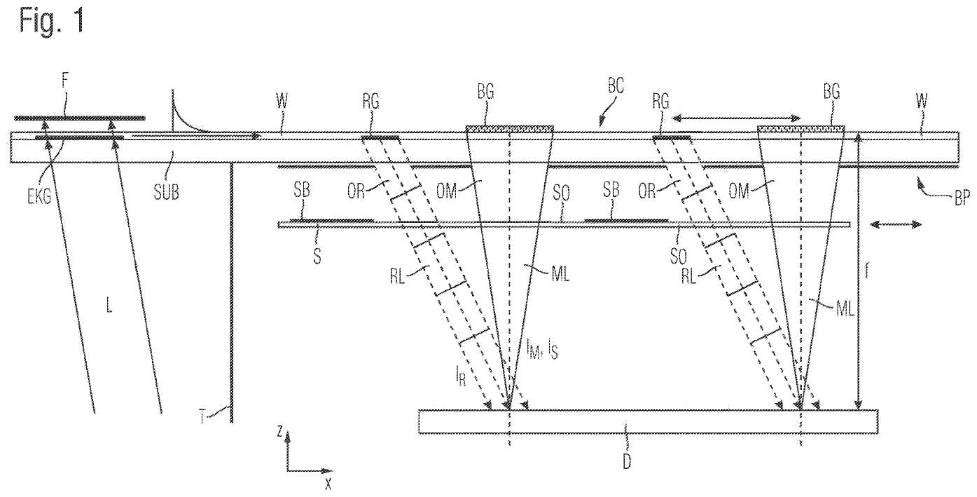

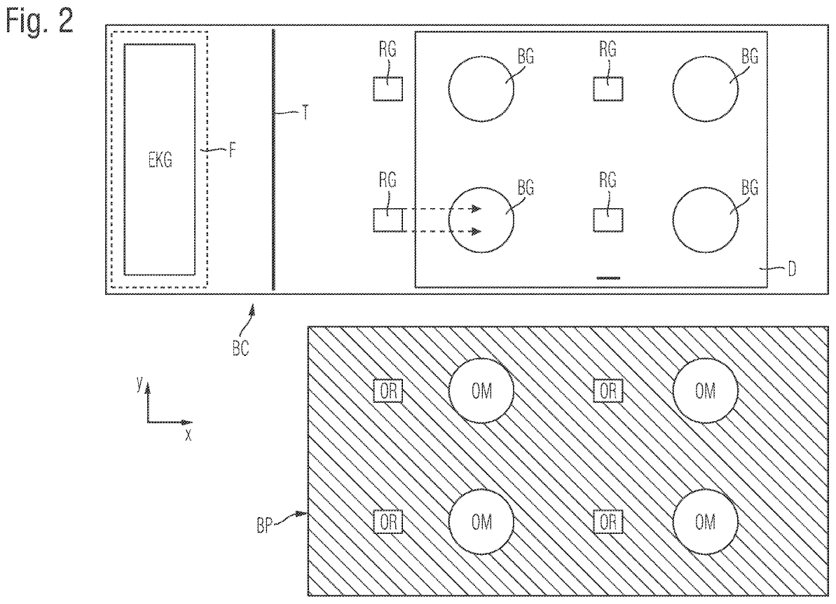

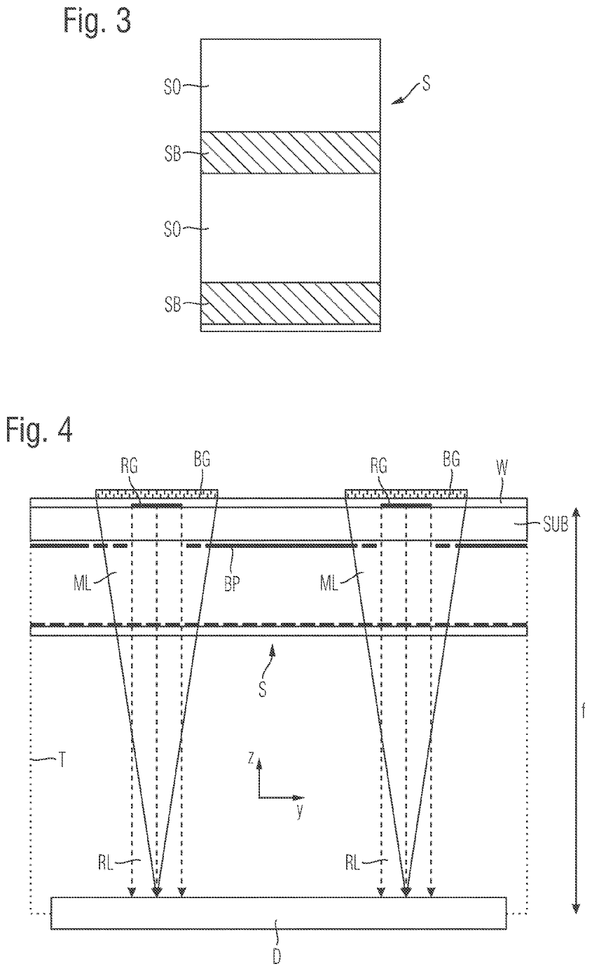

FIGS. 1 through 4 show a first example embodiment in the two side views XZ (FIG. 1) and YZ (FIG. 4) as well as top views of the components biochip and diaphragm plate (FIG. 2) and the shutter (FIG. 3).

Via a coupling grating EKG, light L from a coherent laser light source is coupled into a planar waveguide W, situated on a substrate SUB, of a biochip BC. In this instance, biochip BC denotes substrate SUB with the elements situated on the front and rear side of substrate SUB. Together with the further elements such as a light source and detector as well as the movable diaphragms and additional elements, these results in a biosensor.

The wavelength of the coherent laser light source preferably lies in the range of 400 nm to 1000 nm. Coupling grating EKG is situated on the underside of planar waveguide W. Light L coupled into planar waveguide W propagates in the X-direction (this light mode drops exponentially outside waveguide W) and impinges upon a first reference grating RG. This first reference grating RG is arranged as a linear grating on the underside of planar waveguide W and is preferably produced by the same process steps that also produce coupling grating EKG.

Because of the linear grating form of reference grating RG, decoupled first reference light beam RK is collimated. It impinges upon a detector D having a plurality of individual detectors, which is preferably arranged as a CMOS or a CCD image sensor. Only a small portion of light L propagating in planar waveguide W is decoupled by first reference grating RG. The predominant portion propagates further to a first biograting BG. First biograting BG includes first capture molecules, which are adsorbed in the form of a grating, i.e. like the webs of a grating on the surface of biochip BC. These first capture molecules specifically adsorb first analyte molecules, which are therefore likewise adsorbed in the form of a grating and whose mass coverage is to be measured.

Because of the grating-type adsorption of the first analyte molecules at the capture molecules, a small portion of light L propagating in planar waveguide W is decoupled as a first measuring-light beam ML and also reaches detector D. The grating form of biograting BG, as described in the above-cited PCT Patent Document No. WO 2015/004264, is selected so that the decoupled first measuring-light beam ML is focused on a small focus area on detector D. The grating form thus represents a diffractive lens having the focal length f. First reference grating RG and first biograting BG are selected such that first reference light beam RL and first measuring light beam ML superposition at the location of detector D. This coherent superposition results in a first intensity stripe system, which is detected by detector D and evaluated in an evaluation unit. The superposition of both light beams RL, ML at the location of detector D is able to be achieved by the choice of the decoupling angle of first reference grating RG, for instance, which is given by the grating orientation and by the grating constant of first reference grating RG.

First biograting BG also decouples only a very small portion of light L propagating in planar waveguide W. The predominant part propagates further to a second reference grating RG and a following second biograting BG. Second reference grating RG, identical to the first reference grating RG, is likewise arranged as a linear grating and decouples a second reference light beam RL, which reaches detector D at an offset from the first reference light beam. Second biograting BG includes second capture molecules, which once again are adsorbed in grating form. The grating form is identical to the grating form of first biograting BG and thus also represents a diffractive lens. The second capture molecules differ from the first capture molecules of first biograting BG and thus adsorb different specific analyte molecules whose mass coverage is to be measured as well. Second reference light beam and second measuring light beam RL, ML once again superposition at the location of detector D, impinging at an offset from the first reference and measuring light beam so that they are able to be detected independently. A second intensity stripe system is produced, which is detected by detector D and evaluated in the evaluation unit.

As illustrated in the top view of biochip BC, still further reference and biogratings RG, BG are situated next to first and second reference gratings and biogratings RG, BG in order to allow for the detection of further analyte molecules. As a result, it is possible to examine four different analyte molecules with the aid of a single biochip BC from this exemplary embodiment.

A diaphragm plate BP is introduced into the beam path between biochip BC and detector D. It has openings OR, OM for the plurality of reference and measuring light beams RL, ML and blocks stray light that is produced outside these light beams RL, ML. Openings OR, OM are therefore selected to be as small as possible in order to achieve a high stray light suppression but are sufficiently large so that reference and measuring light beams RL, ML will not be adversely affected to any significant extent. Diaphragm plate BP may be arranged as a thin metal plate having openings OR, OM. As an alternative, it is also possible to apply an absorbent layer on a glass plate and to appropriately provide it with openings OR, OM. This second alternative offers the advantage that this glass plate may simultaneously be a cover plate of an optics module which protects detector D and further optical components from contamination that may be produced when the biochip is introduced or removed.

The evaluation unit evaluates the intensity stripe systems on the focus areas of the measuring light beams ML. Interposed individual detectors or pixels of the image sensor are not used for the evaluation because they detect only stray light that is produced outside the measuring mode and is not relevant in the context of the evaluation. This selection of pixels only in the region of the focus areas corresponds to a virtual diaphragm structure at the location of detector D. Together with diaphragm openings OR, OM of diaphragm plate BP, a diaphragm system is created which allows only light to pass that corresponds to the measuring mode with regard to the location and direction. All other modes, which after all differ from the measuring mode in the light location and/or in the light direction, are blocked. This therefore results in the desired mode filter.

As described above, a series of measurements is required in order to determine scattered measuring intensity I_{M} of biogratings BG, in which either only reference light beams RL or measuring light beams ML or both together are detected. It is therefore necessary to insert a shutter S into the beam path from biochip BC to detector D. This shutter S has openings or transparent regions SO through which the reference and/or measuring light beams RL, ML are transmitted. By shifting shutter S in the x-direction, beam-blocking regions SB are able to be slipped into the beam path of reference light beams RL or into the beam path of measuring light beams RB so that a measurement of intensity values I_{M+S+R}, I_{M+S}, and I_{R} is possible. The measurements of intensity values I_{S+R} and I_{S} are carried out prior to the adsorption of the analyte molecules.

FIGS. 1-4 show further components. For example, a separation wall T separates the region of the beam coupling from the region of the beam detection. In addition, a beam catcher F absorbs the light transmitted through coupling grating EKG. Both reduces the stray light.

### Second Example Embodiment

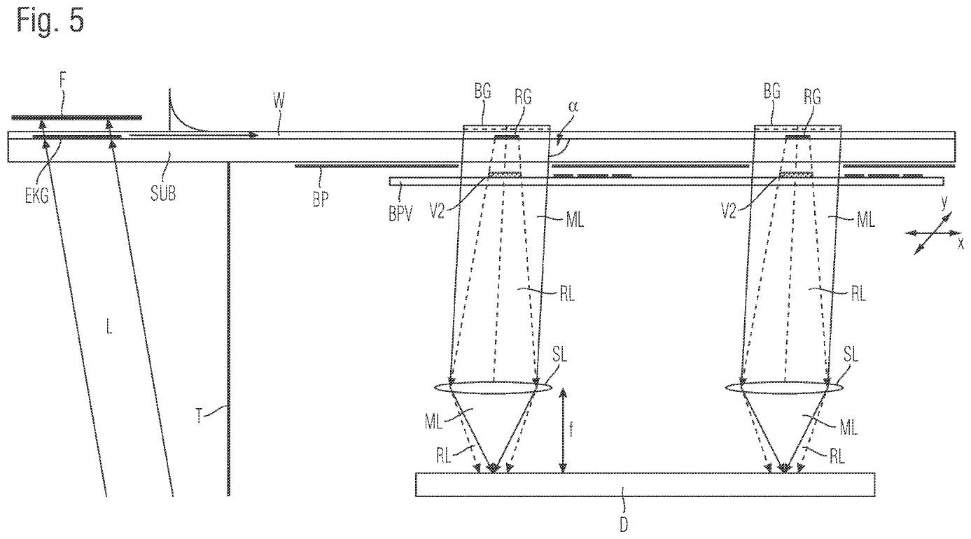

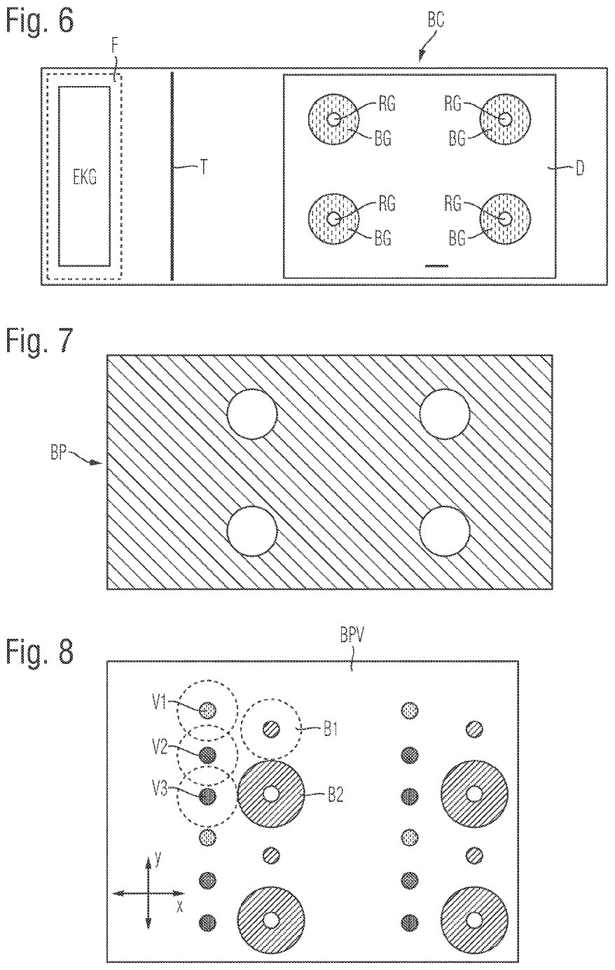

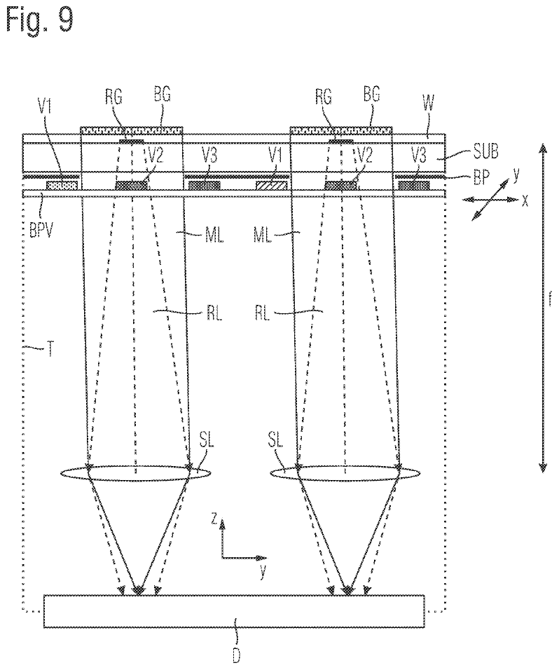

FIGS. 5 through 9 show a second example embodiment of the present invention in the two side views XZ (FIG. 5) and YZ (FIG. 9) as well as in top views of the components biochip (FIG. 6), diaphragm plate (FIG. 7) and combined shutter/delay plate carrier (FIG. 8).

Only the differences from the first example embodiment will be discussed below. Reference gratings RG are situated (in the z-direction) underneath associated biogratings BG where they decouple a small portion of the light in planar waveguide W as a reference light beam RL in the form of spherical waves. To this end, reference gratings RG are arranged as chirped gratings including curved grating lines and act as diffractive dispersion lenses. Biogratings BG, one the other hand, are arranged as linear gratings with a constant grating period and decouple collimated measuring light beams ML from waveguide W. In order to avoid back-reflections of the linear gratings into planar waveguide W by a second order diffraction according to the Bragg condition, the decoupling is carried out under an angle α≠90°. As illustrated in the top view in FIG. 6, reference gratings RG are circularly restricted and enclosed by circular rings with biogratings BG in each case.

The emerging reference light beams RL are thus enclosed by associated measuring light beams ML.

Decoupled measuring and reference light beams ML, RL pass through a stationary diaphragm plate BP (FIG. 7) and then impinge upon a combined diaphragm and phase-delay plate BPV (FIG. 8), which is displaceable in the x- and y-directions. As illustrated in the top view of FIG. 8, diaphragm elements B1, B2 are provided on combined diaphragm and phase-delay plate BPV, which are able to block either the reference or the measuring light beams RL, ML. In addition, there are phase-delay elements V1, V2, V3, which are able to be inserted into the beam path of reference light beams RL and delay the phases of the reference light beams RL by 60°, 180° or 300° in each case. All diaphragm and phase-delay elements B1, B2, V1, V2, V3 are situated in the raster of measuring light beams and reference light beams RL, ML so that the optical effect is always the same for all reference light beams RL and also for all measuring light beams ML.

Due to diaphragm structures B1, B2 and a corresponding x- and y-shift in the combined diaphragm and delay plate, it is possible to acquire intensity values I_{R} and I_{M+S+R}, I_{M+S} (after the addition of the analyte) or I_{S+R} and I_{S} (prior to the addition of the analyte). When inserting the phase-delay elements V1, V2, V3 into reference light beams RL, the phase of the reference light beams is able to be delayed as well and the phases of the corresponding interference terms can thus be determined according to the phase-shift method. Phase-delay elements V1, V2, V3 are made of a transparent, optically denser material than the surrounding medium air, e.g., of glass or a transparent polymer of suitable thickness, in order to obtain the desired phase delay.

In the further beam course, reference and measuring light beams RL, ML impinge upon a lens array plate. Situated thereon in the raster of measuring light beams ML are collimating lenses SL. They focus measuring light beams ML on detector D situated underneath. The distance between collimating lenses SL or the lens array plate and detector D is therefore selected to be equal to the focal length of collimating lenses SL. Reference light beams RL, too, are concentrated on detector D by collimating lenses SL of the lens array plate. However, detector D is not situated in the focal plane in relation to reference light beams RL because reference light beams RL are irradiated in the form of spherical waves.

The use of linear grating structures of biogratings BG and thus of collimated measuring light beams ML in combination with a lens array plate having collimating lenses SL that focus measuring light beams ML on a detector has considerable advantages, which will be described below.

The production of biogratings BG as a linear grating structure is much simpler than that of a diffractive lens structure. A diffractive lens structure features a continual variation of the local grating constants. In the contactless lithography, which is required for the production of biogratings BG, Talbot effects of the mask gratings have an adverse effect on the light imaging from the mask toward substrate SUB of biochip BC to be produced, to the effect that disturbing interferences of different diffraction orders of the mask grating arise and lead to undesired light modulations. In the production of diffractive lens structures, not all local grating constants are imaged to the same satisfactory degree and additional modulations occur. The corresponding disturbances of biogratings BG cause the light of planar waveguide W to be decoupled from planar waveguide W at a lower diffraction efficiency and additional light beams are produced, which interfere with the detection in the form of stray light. Moreover, measuring light beams ML have disturbing intensity fluctuations across their cross-sections, which lead to a larger focus area on detector D and thus to greater measuring noise. These disadvantages do not occur in the production of biogratings BG having linear grating structures. In addition, the lithography for this one grating constant is able to be optimized, for instance by the selection of an optimal exposure divergence, an optimal exposure distance or the selection of an optimal exposure wavelength. With unavoidable fluctuations of the exposure intensity, corresponding fluctuations of the web-gap ratio of biogratings BG do actually occur, but these are constant across their transverse extension. The diffraction efficiency or the intensity of measuring light beams ML thus also remains constant across the transverse extension, so that measuring light beam ML is able to be focused on detector D in a diffraction-restricted manner. This in turn results in less measuring noise.

The fixed grating constant of biogratings BG having a linear grating structure allows the web-gap ratio for this grating constant to be optimized. This leads to a greater decoupling efficiency and thus to a greater intensity of measuring light beams ML.

The decoupling in this example embodiment should be performed at a slight incline to the normal of biochip BC in order to suppress multiple reflections and back-reflections at optical elements and in planar waveguide W. If required, this angle may be realigned again perpendicular to detector D using a suitable lens form of collimation lenses SL of the lens-array plate.

Moreover, in biogratings BG having a linear grating structure, the zone without grating lines described, for example, in European Patent Document No. 2 618 130, is also omitted, the grating lines within the focusing gratings being provided in order to avoid a back-reflection into the waveguide. This reduces the production outlay and increases the intensities of measuring light beams ML due to the larger surfaces of biograting BG.

Another advantage of a biograting BG as a linear grating structure is the constant polarization of collimated measuring light beam ML in contrast to a polarization that varies across the transverse extension in a diffractive grating structure. Also, because of the omission of the curvature, the polarization of the propagating waves is always arranged in parallel with the grating lines, which increases the decoupling efficiency.

As previously described, the use of biogratings having linear grating structures requires subsequent focusing of the measuring light beams and therefore entails the use of at least one collimation lens SL or a lens-array plate (for multiple biogratings BG on a biochip BC). The position tolerances of collimation lenses SL relative to each other are sufficiently small only in a lens-array plate. The adjustment of individual lenses which have to be arranged in a very tight raster is much too complex.

The collimation lenses SL of the lens-array plate may have a refractive as well as a diffractive configuration. The diffractive variant may be produced as a one-stage, binary structure or advantageously in multi-stage form as a blazed structure.

Since the position between detector D and collimation lenses SL or the lens-array plate is fixed, the position of the focus areas on detector D does not change when biochip BC is displaced relative to the scanning optics, which simplifies the evaluation. Such displacements in all three directions in space may occur when the biochip is inserted into an evaluation unit or as a result of thermal drift processes. Only a rotation of biochip BC about the x- or y-axis would displace the focus areas. Biochip BC must therefore be aligned with the aid of stops close to the edges of biochip BC. Because of the small deviation of decoupling angle α from 90°, a rotation about the z-axis is of only minor importance and can also easily be controlled by stops.

Reference light beams RL in the form of spherical waves used in this example embodiment are advantageous because the transverse extension of reference light beams RL on detector D is able to be selected by the focal length of reference gratings RG in the form of diffractive dispersion lenses. It may therefore be configured so that a uniform intensity of reference light beams RL across the focus areas of measuring light beams ML is produced on detector D.

In comparison with the carrier wave method, the phase-shift method used in this instance requires only light beams having low beam inclinations, i.e. a low numerical aperture. Due to the low beam inclinations, the unavoidable, and also multiple, reflections at optical components such as at diaphragm plate BP do not lead to crosstalk from one measuring light beam ML to an adjacent measuring light beam ML. The measuring accuracy is increased accordingly. In addition, measuring beam bundles and associated reference beam bundles ML, RL are decoupled from biochip BC at closely adjacent points. As a result, the temperature influence on the phase shift between measuring and reference light beams ML, RL, which is produced by changes in the refraction index in planar waveguide W, is correspondingly low. Moreover, the computational effort in the evaluation unit is less than in the carrier wave method because no stripe patterns have to be evaluated for the phase determination, but only arithmetic calculations and an arc tangent formation are required.

### Third Example Embodiment

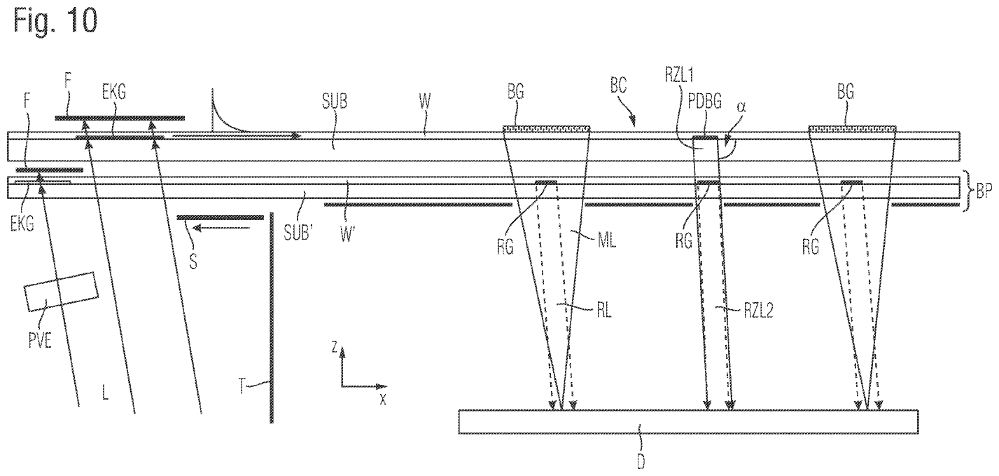

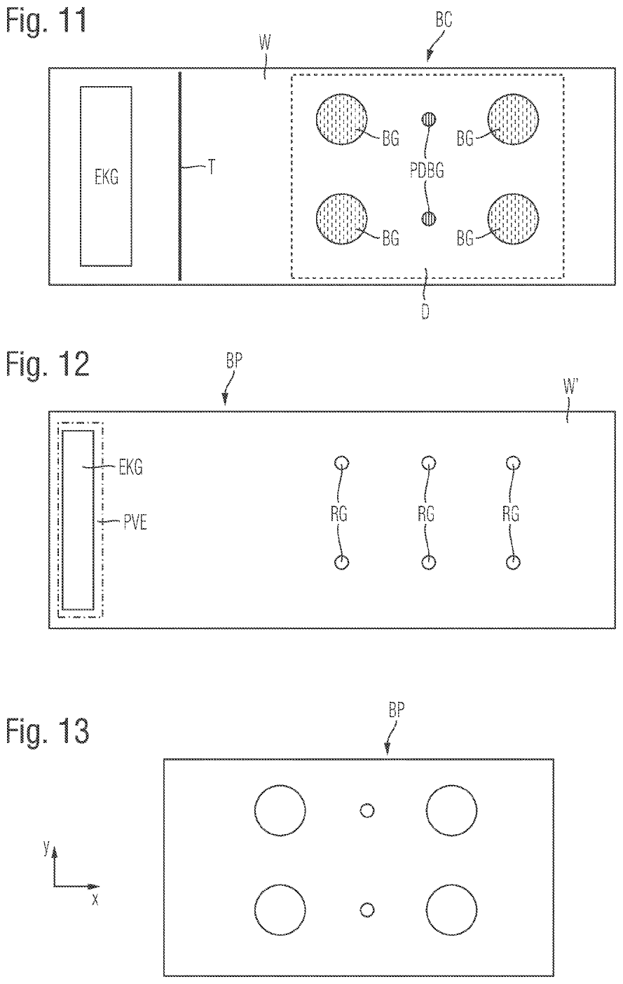

FIGS. 10 through 13 show a third example embodiment in the side views XZ (FIG. 10) as well as in top views of the components biochip-waveguide (FIG. 11), the top side of the diaphragm plate with reference grating-waveguide (FIG. 12), and the underside of the diaphragm plate (FIG. 13). Hereinafter, only the differences from the first example embodiment will be described.

In this example embodiment, biogratings BG are once again arranged as diffractive lenses and focus measuring light beams ML on detector D again. Reference light beams R pass through a diaphragm plate BP. To this end, diaphragm plate BP has a substrate SUB′, a coupling grating EGK, and a separate planar waveguide W. A portion of light L from the coherent laser light source is phase-shifted via an electro-optical phase delay element PVE in the form of a liquid crystal element or an electro-optic modulator and coupled into planar waveguide W of diaphragm plate BP via coupling grating EKG. In waveguide W′, the light propagates in the +x-direction to reference gratings RG, which decouple reference light beams RL. Reference gratings RG are arranged as linear gratings so that the reference light beams are collimated. The grating constant of the reference gratings is selected such that reference light beams RL decouple at a slight angle (α≠90) to the normal direction of biochip BC in order to avoid back-reflections into waveguide W′. This is done analogously to the Bragg zones described in European Patent Document No. 2 618 130, in which grating lines are left out in the respective biogratings in order to avoid reflections into the planar waveguide according to the Bragg condition. Reference gratings RG are positioned relative to biogratings BG such that reference light beams RL come to overlap with the associated measuring light beams ML at the location of detector D and thus interfere. The phase shift of reference light beams RL by the electro-optic phase-delay element PVE allows for a shift of the relative phase between measuring and reference light beams ML, RL, and thus for the determination of the relative phase in an evaluation unit according to the phase-shift method discussed above.

A shutter S, which is movable in the x-direction, makes it possible to block measuring or reference light beams ML, RL even before light L impinges upon respective coupling gratings EKG.

In addition to biogratings BG, biochip BC furthermore carries a referencing grating, which is also referred to as a phase-drift reference grating PDBG. A small portion of light L propagating in planar waveguide W of the biochip is decoupled by this first referencing grating PDBG and generates a first referencing light beam RZL. Referencing grating PDBG is arranged as a linear grating so that first referencing light beam RZL1 emerges in collimated form. It is then detected by detector D. Diaphragm plate BP carries a further reference grating RG, which is situated underneath first referencing grating PDBG on biochip BC and also arranged as a linear grating. Here, too, a small portion of light L propagating in planar waveguide W of diaphragm plate BP is decoupled so that a collimated, second referencing light beam RZL2 is produced. First and second referencing light beams RZL1, RZL2 overlap and interfere at the location of detector D.

With the aid of electro-optic phase-delay element PVE, second referencing light beam RZL2 is able to be shifted in phase and in this case as well, allows for the determination of the relative phase of the first and second referencing light beams RZL1, RZL2. This relative phase depends on the relative position of biochip BC and diaphragm plate BP. However, the relative position also influences the relative phases between measuring light beams and associated reference light beams ML, RL. By determining the relative phase between first and second referencing light beams RZL1, RZL2, the portion of the relative phases of measuring light beams and associated reference light beams ML, RL that is a function of the relative position of biochip BC and diaphragm plate BP is able to be determined and subtracted. Drift of the relative position of biochip BC relative to diaphragm plate BP during the measuring period is thereby able to be compensated. In this context it should be noted that there is a sensitive direction for the relative position that determine the relative phases of measuring and associated reference light beams ML, RL. In the same manner there is a sensitive direction for the relative phase of first and second referencing light beam RZL1, RZL2. Both sensitive directions are given by the direction of light beam L upstream from coupling grating EKG and by the direction of the decoupled light beams. The two sensitive directions should be identical, if possible. At the same coupling angle for biochip BC and diaphragm plate BP, the condition for an identical decoupling direction for measuring light beams ML, the reference light beams and the first and second referencing light beams RZL1, RZL2 comes about. This can be achieved by a suitable grating constant and grating orientation of reference gratings RG and referencing gratings PDBG.

If needed, additional referencing gratings PDBG are able to be provided on biochip BC and associated reference gratings RG on diaphragm plate BP. Apart from the compensation of linear displacements between biochip BC and diaphragm plate BP, the corresponding further measurements of the relative phases also allow for the compensation of rotations. This results in a particularly accurate variant.

An advantage of this example embodiment is that reference grating RG simply has to be structured in a waveguide W fixedly installed in the detection apparatus, instead of providing waveguide W in every biochip. In addition, the calibration is simplified as well. Also, no movable parts are required for the phase shift of reference light beams RL.

Because of the spatial separation of light beams L that impinge upon coupling gratings EKC of the biochip or the diaphragm plate BP, a separate adjustment of their intensity is possible with the aid of corresponding components in the beam path. In this manner, the intensity ratio of measuring and reference light beams ML, RL is able to be adjusted and optimized for an optimal detection. In this case, shutter S is situated upstream from coupling gratings EKG so that less stray light is created when one of the two light beams is blocked.

### Fourth Example Embodiment

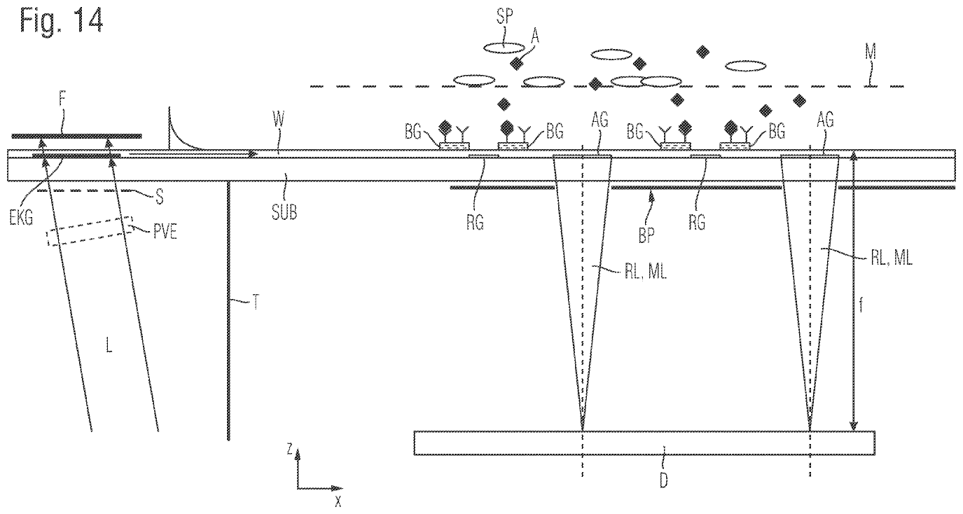

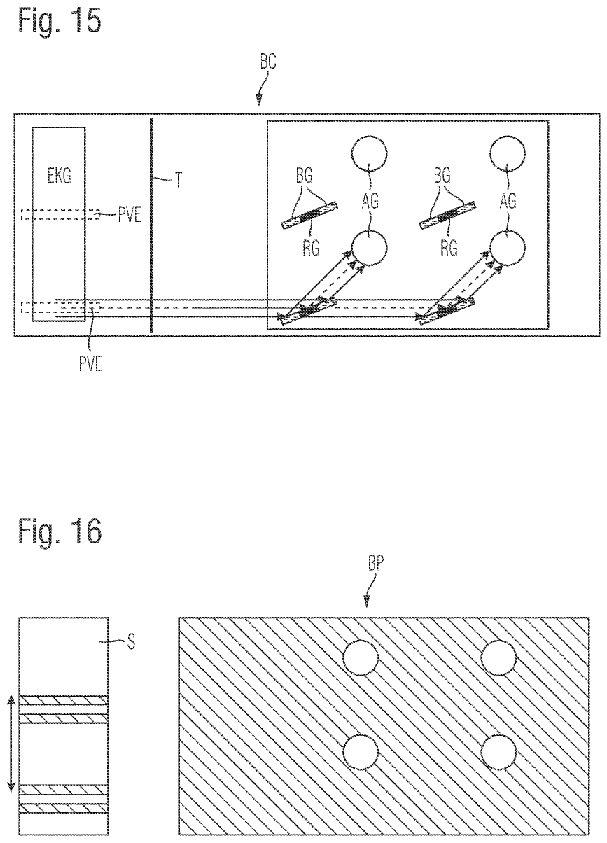

FIGS. 14 through 16 show a fourth example embodiment in the side view XZ (FIG. 14) as well as in top views of the components biochip (FIG. 15) as well as the diaphragm plate and the combined shutter/delay plate carrier (FIG. 16).

Only the differences from the first example embodiment will be described below.

This example embodiment is based on a system which is described in European Patent Document No. 2 929 326. Biogratings BG only deflect light L in planar waveguide W but do not decouple it from planar waveguide W. Biogratings BG are arranged as linear gratings. The decoupling from waveguide W is obtained with the aid of additional decoupling gratings AG.

Similar to the afore-described example embodiments, light L first passes through electro-optic phase-delay elements PVE (for the portion of the light that will later be directed onto reference grating RG) and a shutter S so that the light components on biograting and reference grating BG, RG are able to be dimmed independently of each other. The coupling of the light is carried out similar to the first example embodiment via a coupling grating EKG.

Light L propagating in the x-direction then impinges upon a first linear, bipartite biograting BG in whose center a first reference grating RG is provided. The grating lines of both gratings BG, RG are arranged in an equidistant fashion, at an incline to the propagation direction of light L, and satisfy the Bragg condition for the deflection of the light in the waveguide in the direction of decoupling grating AG. Via angle θ of light L to the grating lines, the spacing of grating lines d is therefore linked with the wavelength of the light in waveguide A. The diffraction order n is usually 1 in order not to generate any additional, disturbing diffraction orders and to increase the diffraction efficiency.

The small portion of total light L deflected by biograting BG and reference grating RG impinges upon a focusing decoupling grating AG on the underside of waveguide W, which directs both components to detector D and brings them to superposition there. In order to ensure a reliable superposition of both components, reference grating RG may be provided with a slight curvature in order to ensure a small divergence of this reference light beam RL. A continual variation of the coupling angle at coupling grating EGK in the y-direction via a suitable actuator is also provided in order to satisfy the Bragg condition of biograting BG and to optimize the measuring intensity in this manner.

In the next biograting and reference grating BG, RG the light component remaining in waveguide W is deflected at another location and decoupled.

In addition, a particle spacer M having a suitable pore size is provided. This measure may also be provided in connection with all other example embodiments. The goal is to keep undesired scattering particles SP (e.g., cells) away from waveguide W through filtration. For this purpose, particle spacer M is provided outside the evanescent field of waveguide W and the pore size is selected so that the biomolecules or analytes A to be analyzed are allowed to pass through, whereas undesired larger particles SP are kept behind in the fluid supernatant. Particle spacer M is able to be brought close to waveguide W or onto waveguide W in the form of a diaphragm or also as a molecule layer or porous cover layer. Particle spacer M prevents larger particles such as tumor cells (typical diameter 10-30 pm) from changing the stray light background when they reach the evanescent field or come close to waveguide W.

One advantage of this example embodiment including particle spacer M is that it is thereby ensured that the stray light background is able to be measured with and without measuring wave under identical conditions without being changed by larger particles or cells introduced with the analyte medium.

### Fifth Example Embodiment

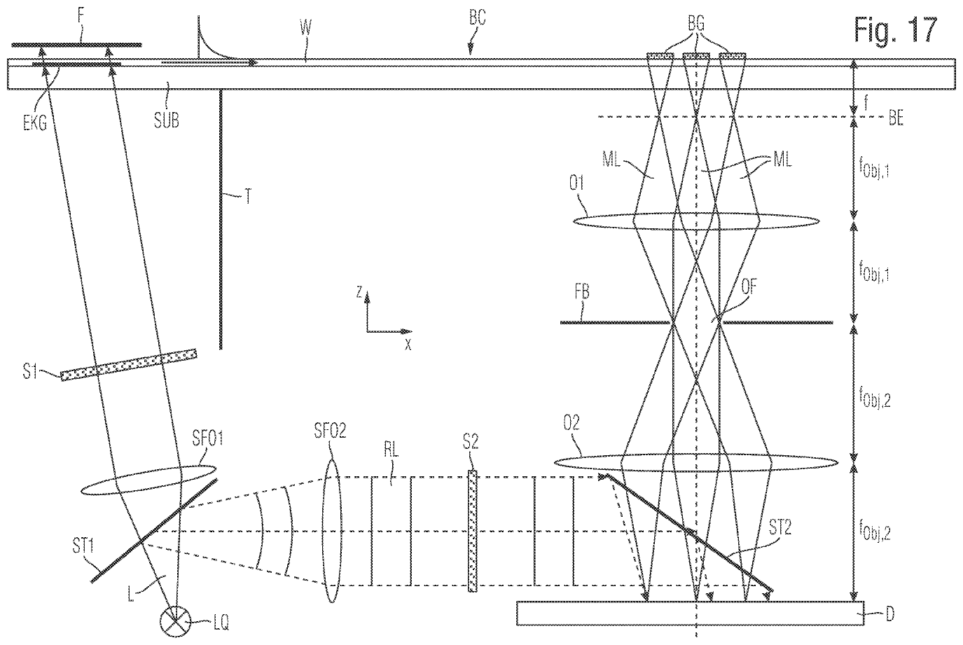

FIG. 17 shows a fifth example embodiment in the XZ side view. Described are mainly the differences from the first example embodiment.

With the aid of a first beam splitter ST1, light L from a coherent laser light source LQ is split up into two components, which are subsequently used to generate measuring light beams ML (first component) and external reference light beam RL (second component) separately from one another.

After passing through a suitable first beam-forming optics SF01 and a first shutter S1, a first component of the light split up at beam splitter ST1 is coupled via a coupling grating EKG into a planar waveguide W of a biochip BC situated on a substrate SUB. In this embodiment, biogratings BG are once again arranged as diffractive lenses having focal length f and focus measuring light beams ML on a focal plane BE, which is located at a distance f from waveguide W. Shutter S1, which is movable in the x-direction, makes it possible to block measuring light beams ML even before light impinges upon coupling grating EKG.

Focal plane BE is imaged with the aid of two objectives O1, O2 having focal lengths f_{Obj,1} and f_{Obj,2} onto a detector D, which is situated at a distance 2f_{Obj,1}+2f_{Obj,2} from focal plane BE. 4f-imaging with an enlargement M=−1 thus results in the case of two objectives O1, O2 having identical focal widths f_{Obj,1}=f_{Obj,2}=f_{Obj}. The optical imaging of focal plane BE onto detector D used in this example embodiment is particularly advantageous because a Fourier plane results at distance 2f_{obj,1} from focal plane BE or at a distance 2f_{Obj,2} from detector D, into which a Fourier diaphragm FB having a suitable opening OF is introduced so that k-space filtering (i.e. angle filtering) is obtained. In this manner, the numerical aperture of the detection optics is able to be adapted such that undesired stray light, which is irradiated into modes other than the measuring mode, is blocked. This therefore results in a desired mode filter. Fourier diaphragm FB is arranged to be displaceable in the X- and Y-directions so that tilting of measuring light beam ML, decoupled from biochip BC, about the Rₓ- and R_{y}-axis is able to be compensated.

A second component of light L split up at beam splitter ST1 is collimated with the aid of a suitable second beam-forming optics SFO2 and used as an external reference light beam RL. A second shutter S2, which is movable in the z-direction, makes it possible to block reference light beam RL. Next, reference light beam RL is directed to detector D with the aid of a second beam splitter ST2 (or some other deflection element used for the deflection and beam convergence) and brought to overlap with measuring light beam ML, so that both interfere at the location of detector D. In order to be able to perform a phase measurement according to the carrier wave method, angle R_{y} of second beam splitter ST2 is to be selected such that irradiated reference light RL is irradiated under an angle greater than the numerical aperture of the measuring light and stray light component in the measuring mode. In addition, second beam splitter ST2 may be arranged to be adjustable by R_{y} in order to appropriately correct the angle of reference light beam RL in the event of drift of the angle of measuring light beam ML and stray light. If no mechanical adjustment is provided, then the period of the intensity stripe system that is created by the interference of measuring light beam ML and reference light beam RL should be estimated and the measured phases be corrected by the associated gradient error.

In a deviation from the illustrated example embodiment, the phase measurement can also be carried out according to the phase-shift method. In this case, angle R_{y} of second beam splitter ST2 is once again freely selectable and need not necessarily be adjustable. In order to delay the phase of reference light beam RL by 60°, 180° or 300°, a phase-delay element must then be introduced into the beam path of reference light beam RL at a suitable location.

In a deviation from the illustrated example embodiment, the second portion of the light split up at first beam splitter ST1 may also be used to illuminate a small opening which, in addition to first opening OF, is located in Fourier diaphragm FB in the x-direction at an offset from the optical axis. This small illuminated opening acts like a point light source in the Fourier plane of second objective 02 so that a planar reference light beam is produced, which is directed to detector D and brought to overlap with measuring light beam ML, i.e. is brought to interference therewith at the location of detector D. The distance between this small second opening and the optical axis determines angle R_{y} at which reference light beam RL is irradiated onto detector D in a tilted manner with respect to measuring light beam ML and the stray light; it may once again be selected to be adjustable in order to allow for a corresponding adjustment of the angle of reference light beam RL in the event of drift of the angle of measuring light beam ML and stray light. The light path from first beam splitter ST1 to Fourier diaphragm FB may also be bridged by conducting the light in an optical fiber.

In contrast to the example embodiments described up to this point, reference light beam RL is decoupled not by a multitude of reference gratings RG but by a first beam splitter ST1. Only one reference light beam RL is generated and used for measuring all measuring light beams ML. This example embodiment is particularly advantageous because no space has to be reserved on the surface of biochip BC for reference gratings RG so that biogratings BG—in contrast to the first and fourth example embodiments—may be arranged more tightly or—in contrast to the second and third example embodiments—may be arranged across the full surface. It is also advantageous that the complex structuring of reference gratings RG is omitted and only beam splitters ST1, ST2 are required, which are fixedly installed in the detection apparatus.

A disadvantage of this example embodiment first of all is that the optical paths from reference light beam RL and measuring light beam ML do not agree. In order to achieve interferometric stability, a so-called “common path” geometry is usually selected, in which the optical paths of reference light beam RL and measuring light beam ML largely match, i.e. pass through the same optical elements (as in the first, second and fourth example embodiments, and, with restrictions, also in the third example embodiment). This ensures that mechanical or thermal drift processes affect both light beams RL, ML to the same extent, so that the relative phase remains constant. However, the solution described in this fifth example embodiment represents what is referred to as a “double path” geometry due to the different optical paths for light beams RL, ML, which are susceptible to such drift processes.

However, this disadvantage can be remedied in a particularly simple manner. Since unavoidable stray field E_{S} is mainly produced by scattering at the stationary roughness of substrate SUB, phase distribution φ_{S} of the resulting speckle background is constant over time and space and may be used as an intrinsic phase standard in order to measure and compensate drift of the relative phase between reference light beam RL and measuring light beam ML. A common phase offset of the speckle background, which may occur through drift of the biochip relative to the light source and/or relative to the detector, is allocated to a phase shift of the reference wave in this instance, which would have the same effect.

For this purpose, intensity distributions I_{S+R}, I_{S} and I_{R} are recorded at a first instant the relative phase position between the stray field and the irradiated reference field being assumed to be φ_{S}−φ_{R}. At a later instant t₂, intensity distribution I_{S+R}′ is measured once again, the relative phase position between the stray field and the irradiated reference field now being assumed to be φ_{S}−φ_{R}′. Under the above condition that the phase of the stray light is constant (φ_{S}=const.), it is then possible to calculate the difference of the reference phase between the instants t₁ and t₂ at every location of two-dimensional detector D (i.e. per pixel), based on the following relationship:

$$Δ {φ}_{R} = {φ}_{R}^{′} - {φ}_{R} = \{ \begin{matrix}arccos ( \frac{\begin{matrix}{I}_{S + R} - \\ {I}_{S} - {I}_{R}\end{matrix}}{2 \sqrt{{I}_{S}} \sqrt{{I}_{R}}} ) - arccos ( \frac{\begin{matrix}{I}_{S + R}^{′} - \\ {I}_{S} - {I}_{R}\end{matrix}}{2 \sqrt{{I}_{S}} \sqrt{{I}_{R}}} ) f \ddot{u} r {I}_{S + R}^{′} < {I}_{S + R} \\ - arccos ( \frac{\begin{matrix}{I}_{S + R} - \\ {I}_{S} - {I}_{R}\end{matrix}}{2 \sqrt{{I}_{S}} \sqrt{{I}_{R}}} ) + arccos ( \frac{\begin{matrix}{I}_{S + R}^{′} - \\ {I}_{S} - {I}_{R}\end{matrix}}{2 \sqrt{{I}_{S}} \sqrt{{I}_{R}}} ) f \ddot{u} r {I}_{S + R}^{′} > {I}_{S + R}\end{matrix}$$

Phase drift Δφ_{R}, measured per pixel, between reference light beam RL and stray light can then be estimated with the aid of a wave-front model, which includes corresponding degrees of freedom for different drift processes (phase lift, phase tilt, etc.), so that a total phase drift Δφ_{R} is obtained and able to be compensated, usually by means of subtraction.

Because stray light and measuring bundle ML are produced at the same location on waveguide W and are imaged onto detector D along the same optical path, their relative phase positions Δφ_{MS}=φ_{M}−φ_{S} are constant over time. Thus, if the phase of reference light beam RL drifts by Δφ_{R} relative to phase φ_{S} of the stray light, it also drifts by Δφ_{R} relative to phase (pm of measuring light beam ML. Thus, the phase drift between reference light beam RL and measuring light beam ML is determined, so that interferometric stability is able to be established between the two beam bundles.

As a rule, instant t₂ for which the phase drift between reference light beam RL and measuring light beam ML is to be determined lies after the instant of the analyte addition. In this case, intensity distribution I_{S+R}′ is no longer accessible. However, since the signal intensity changes only within a small focus area of measuring light beam ML when the analyte is added, I_{M+S+R}≈I_{S+R}′ applies outside the focus area. As a result, the unchanged speckle background outside the focus area may continue to be used as the intrinsic phase standard, and the corresponding evaluation of phase drift Δφ_{R} takes place analogously according to the above formula.

Lateral shifting of the biochip between the measurements is also able to be determined by a correlation of the speckle background. In a measurement without reference light beams, the intensity distribution of the speckle background is used for this correlation. With a reference light beam, it is more advantageous to utilize the location-dependent phase distribution for the correlation. The lateral shifting is able to be corrected by shifting the pixel allocations with the aid of software.

One advantage of this method is that the speckle background is able to be used as an intrinsic phase standard across the entire detector area, which means that no additional reference gratings are required.

In connection with the exemplary embodiments described herein, the generalizations addressed below may be possible either in isolation or in combination. It should be understood that the example embodiments described herein should not be considered as restricting the generality and are able to be modified accordingly without affecting the basic functional principles of the different example embodiments.
For example, coupling gratings EKG and/or reference gratings may be obtained not only on the underside of waveguide W but in the same manner also on the topside of waveguide W.
Instead of the excitation of biograting BG and/or reference grating RG via light L propagating in waveguide W, the excitation may also be obtained by a light beam totally reflected at the boundary surface of biochip BC. Biogratings BG and reference gratings RG are situated at this boundary surface. The evanescent electrical field of the totally reflected light then interacts with the respective gratings in entirely the same manner as in the variant featuring an excitation via the waveguide.
Instead of a camera (i.e. a 2D array of photodetectors), it is also possible to use as a detector D a planar single detector per detection location and a diaphragm having the diameter of the measuring field, i.e. the diameter of the measuring mode.
From the literature, a diffraction grating displaceable perpendicular to the beam is also referred to as a phase shifter because the phase varies in its diffraction orders as a function of the position of the webs and gaps relative to the beam. As an alternative, a mirror, moved via a piezo actuator, for example, may also vary the beam path of the reference beam in order to vary the phase.
If the reference wave is polarized perpendicular to the measuring wave, for instance by a suitably oriented λ/2 lamella introduced into the reference beam, it is possible to select, via a rotatable polarization filter upstream from the detector, which beam components one would like to monitor. Parallel to the polarization of the reference and/or measuring wave, only the particular wave is measured, at a setting between 0° and 90° relative to the polarization of the reference wave. The relative strength of the two partial waves can then be adjusted so that an optimal interference contrast (see above) is obtained and an interference on the detector is thereby able to be brought about.
In addition, separating webs are able to be introduced between the individual detection locations in all variants in order to prevent crosstalk.
The detector resolution and the focus diameter of biograting BG should be selected so that the focus diameter lies in the range of 5 to 50 pixels.
The detector resolution and the stripe spacing in the carrier wave method should be selected so that the stripe spacing lies within the range of 5 to 50 pixels.
Reference gratings RG may be applied in the carrier wave method both upstream (as illustrated in the first exemplary embodiment) and downstream from biograting BG at an offset in the x-direction. A placement with an offset in the y-direction or combinations thereof is possible as well. An advantage of an offset from biograting BG only in the y-direction is that the optical wavelength in waveguide W has an identical length for reference gratings and biogratings RG, BG, which minimizes drift in the phase between the reference grating and biograting. If a reference grating is applied upstream and downstream from the biograting in the x-direction in each case, a compensation of the phase drift is also able to be performed computationally in that the phase difference with respect to the biograting is calculated once in each case using one of the two reference gratings. Phase drift of the two reference gratings acts in reverse and can be corrected in this manner.
In addition, a reference grating RG (e.g., by superposition of two grating structures rotated relative to each other, or the generation of a strongly divergent wave) is also able to generate reference waves for a plurality of surrounding biogratings BG. The diaphragm structure underneath selects from the generated reference waves the matching partial wave for the respective biograting BG.
Instead of the movable shutters (S), it is also possible to use electronically switchable elements such as LCDs for the blocking or the release of light beams.

1-10. (canceled)

11. A diffractive biosensor for selective detection of biomolecules, comprising:
a substrate;
an optical biograting arranged on the substrate and including periodically arranged receptors for the biomolecules, an efficiency of a diffraction of incident light and an intensity of a measuring light beam arriving in a detector being a function of a mass coverage of the biograting with the biomolecules to be detected; and
a reference light beam generation device adapted to generate a reference light beam directed to the detector by which a phase position of stray light arriving in the detector relative to a measuring light beam is determined.

12. The diffractive biosensor according to claim 11, wherein the reference light beam generation device includes a reference grating and/or a beam splitter adapted to deflect a portion of incident light as the reference light beam to the detector.

13. The diffractive biosensor according to claim 11, further comprising a movable element having transparent regions and light blocking regions adapted to selectively block the reference light beam or the measuring light beam.

14. The diffractive biosensor according to claim 11, further comprising an electronically switchable diaphragm adapted to selectively block the reference light beam or the measuring light beam.

15. The diffractive biosensor according to claim 11, wherein the biograting is provided on a waveguide arranged on the substrate in a planar manner.

16. The diffractive biosensor according to claim 15, wherein a reference grating of the reference light beam generation device is provided in the waveguide and arranged to a side of the biograting.

17. The diffractive biosensor according to claim 11, wherein the reference light beam generation device includes a first beam splitter adapted to deflect a portion of incident light as the reference light beam to a second beam splitter adapted to superpose the reference light beam with the measuring light beam and deflect the superposed light beams to the detector.

18. The diffractive biosensor according to claim 11, wherein the reference light beam generation device includes a first beam splitter adapted to deflect a portion of incident light as the reference light beam to a deflection element adapted to superpose the reference light beam with the measuring light beam and deflect the superposed light beams to the detector.

19. The diffractive biosensor according to claim 17, wherein a first objective and a second objective are arranged in a beam path of the measuring light beam downstream from the biograting and upstream from the second beam splitter, and a Fourier diaphragm is arranged in a Fourier plane between the first objective and the second objective.

20. The diffractive biosensor according to claim 18, wherein a first objective and a second objective are arranged in a beam path of the measuring light beam downstream from the biograting and upstream from the deflection element, and a Fourier diaphragm is arranged in a Fourier plane between the first objective and the second objective.

21. The diffractive biosensor according to claim 11, wherein the diffractive biosensor includes a plurality of reference light beam generation devices and a plurality of biogratings, the diffractive biosensor further comprising a lens array including a plurality of collimation lenses arranged in a raster of the biogratings, the lens array adapted to direct light of the reference light beam generation devices and of the biogratings onto the detector.

22. A method for determining a phase drift between a reference light beam and a measuring light beam in a device as recited in claim 11, wherein a speckle background, which is stable in space and time, is used as an intrinsic phase standard.

23. The method according to claim 22, wherein a phase offset between the speckle background and the reference light beam and/or the measuring light beam is ascertained at different points in time, and a compensation value for the phase drift is ascertained from the phase offset, to establish interferometric stability between the reference light beam and the measuring light beam.
